(19) United States
(12) Patent Application Publication
(10) Pub. No.: US 2003/0101160 A1
(43) Pub. Date: May 29, 2003

(54) Method for safely accessing shared storage

(75) Inventors: Chandrasekharan Seetharaman, Portland, OR (US); Gerrit Huizenga, Portland, OR (US)

Correspondence Address: IBM CORPORATION, IP LAW DEPT, ED02-905, 15450 SW KOLL PARKWAY, BEAVERTON, OR, 97006-6063, US

(73) Assignee: International Business Machines Corporation, Armonk, NY

(21) Appl. No.: 09/995,028

(22) Filed: Nov. 26, 2001

(51) Int. Cl. G06F 7/00

(52) U.S. Cl. 707/1

(57) ABSTRACT

A method for accessing shared storage media in a multinode and/or multicluster computing environment is provided. Each storage media has a label for identifying ownership of the storage media, the label being based on a hard attribute which is preferably a hardware identifier containing the vendor, product, and serial number of the storage media. A node is permitted access to the storage media if a type field in the label indicates the media is node-owned and a node identifier in the label matches the node identifier of the node. Alternatively, a node in a cluster is permitted access to the storage media if a type field in the label indicates the media is cluster-owned and a cluster identifier in the label matches a cluster identifier of the node. The label may be expanded to include additional fields for other purposes.

### BACKGROUND OF THE INVENTION

1. Technical Field

This invention relates to accessing shared storage media in a computing environment. More specifically, the invention relates to a multinode computing environment and coordination of access to the shared storage media.

2. Description of the Prior Art

A storage area network (“SAN”) is an increasingly popular storage technology. One advantage of a SAN is that it allows multiple computers to access a set of storage devices, also known as storage media. However, use of a SAN has an associated problem of protecting the contents of a storage media written by one node from being accidentally overwritten by a different node that can physically access the storage media. Accordingly, in a SAN it becomes important for every node to assess it's access rights before accessing the contents of the storage media.

There are several current options available for providing protection to the shared storage media in a multinode computing environment. One option is that of physical isolation. This option connects a node or cluster to the storage media only if the node or cluster has access privileges to the storage media. However, there are several disadvantages associated with this option, including cost. Physical isolation of a node or cluster does not take advantage of the physical capabilities of the SAN. Another disadvantage with physical isolation is the need to physically move the storage media in order to change accessibility to the storage subsystem. Accordingly, the physical isolation option for protecting the shared storage media is inefficient.

A second option for protecting the shared storage media is logical isolation, as in fibre channel zoning. The logical isolation option limits access to the storage media by a node and/or cluster at the hardware level. One disadvantage associated with logical isolation include complex hardware associated therewith, which generally results in increased costs and complex administrative efforts that are required when changing ownership of a storage media. This option may sometimes force a reboot of the nodes. Another disadvantage with logical isolation is that this form of isolation is not available for all types of storage technologies. Accordingly, the logical isolation option for protecting the shared storage media is not universally available for all storage technology and is expensive to operate.

Finally, a third option for protecting the shared storage media is software protection. This option requires the storage media to be configured into a file system. In this option, the storage media is protected by a node(s) which then acts as a master. However, there are several limitations associated with this option, including lack of raw access to the storage media and the costs associated with a master node(s). The requirement that all operations be processed through the master node requires a dedication of a node as a master node. In addition, the software protection is slower than the other prior art solutions. Accordingly, the software option for protecting the shared storage media is expensive and inefficient.

Each of the three current prior art solutions outlined above have drawbacks associated therewith. Accordingly, it is therefore desirable to provide a method for safely accessing shared storage media in a computing environment having two or more nodes and/or two or more clusters that overcomes the drawbacks of the prior art.

### SUMMARY OF THE INVENTION

It is therefore an object of the invention to safely access shared storage media in a multiple operating system environment.

A first aspect of the invention is a method for safely accessing shared storage media in a computing environment having two or more nodes. Access rights of at least two nodes to the shared storage media are established, based in part on a hard attribute of associated storage media. The hard attribute preferably comprises a hardware identifier field, and is preferably part of a label which also includes a type field, a node identifier field, and a cluster identifier field.

A second aspect of the invention is a computing environment having two or more nodes, shared storage media, a hard attribute on associated storage media, and an access manager responsive to the hard attribute. A third aspect of the invention is an article comprising a computer-readable signal bearing medium. The article includes means in the medium for accessing shared storage media, for establishing access rights, and for managing an access request. The storage media has associated storage media having a hard attribute.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a storage area network in a multinode environment.

FIG. 2 is a block diagram of a storage area network in a multicluster environment.

FIG. 3 is a block diagram of a storage area network in a multinode and multicluster environment.

FIG. 4 is a flow chart illustrating the process for accessing shared storage media according to the preferred embodiment of this invention, and is suggested for printing on the first page of the issued patent.

FIG. 5 is a flow chart illustrating the process for updating an activity counter while accessing the storage media.

FIG. 6 is a flow chart illustrating the process for utilizing an activity interval in conjunct ion with an activity counter for changing a storage media label.

### DESCRIPTION OF THE PREFERRED EMBODIMENT

### Overview

A node is a computer running a single operating system instance. Each node in a computing environment is connected to a set of storage media. A cluster is a set of multiple nodes coordinating access to a set of shared storage subsystems typically through a storage area network. It is important for each node in a computing environment to assess its rights to access the storage media prior to accessing the storage media. In addition, it is important for each node to ensure the coherence of updates to the storage media. Accordingly, the method disclosed herein teaches safe access of shared storage media in a multinode and/or multicluster computer operating environment.

### Technical Background

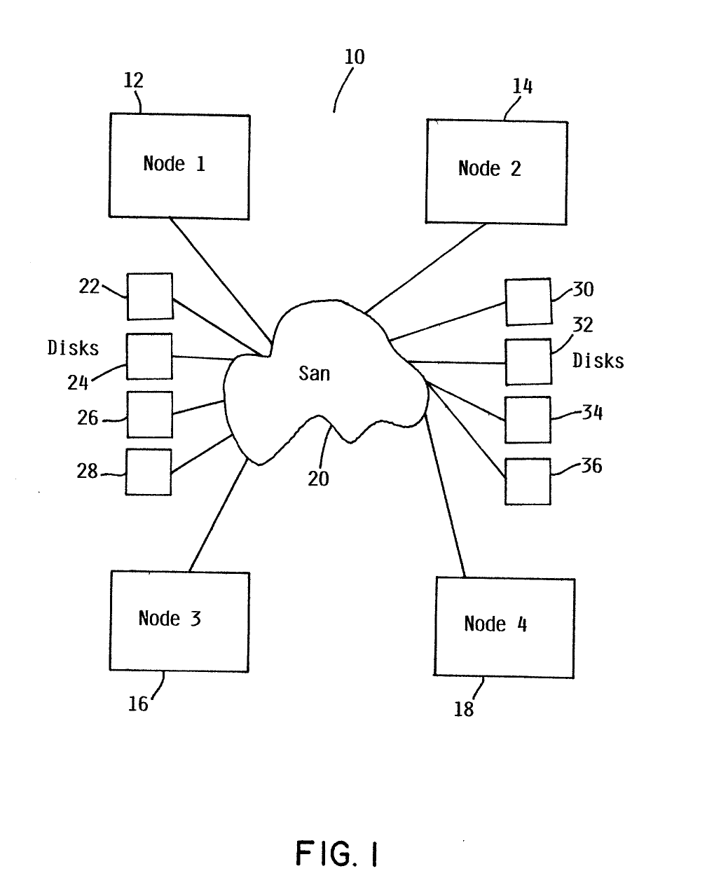

FIG. 1 is a block diagram 10 of a multinode computing environment having four nodes with each node having physical access to the storage media 22-36 connected to the storage area network 20. Each node 12, 14, 16 and 18 is in communication with the storage area network 20. The system includes a plurality of storage media 22-36 which are also in communication with the storage area network 20. The interconnection of each of the nodes 12, 14, 16 and 18 with the storage area network 20, as well as the interconnection of each of the storage media 22-36 with the storage area network 20, allows each of the nodes 12, 14, 16 and 18 to access each of the storage media 22-36 in the computing environment. Accordingly, FIG. 1 is a computing environment wherein each node can access the storage media 22-36 through the storage area network 20.

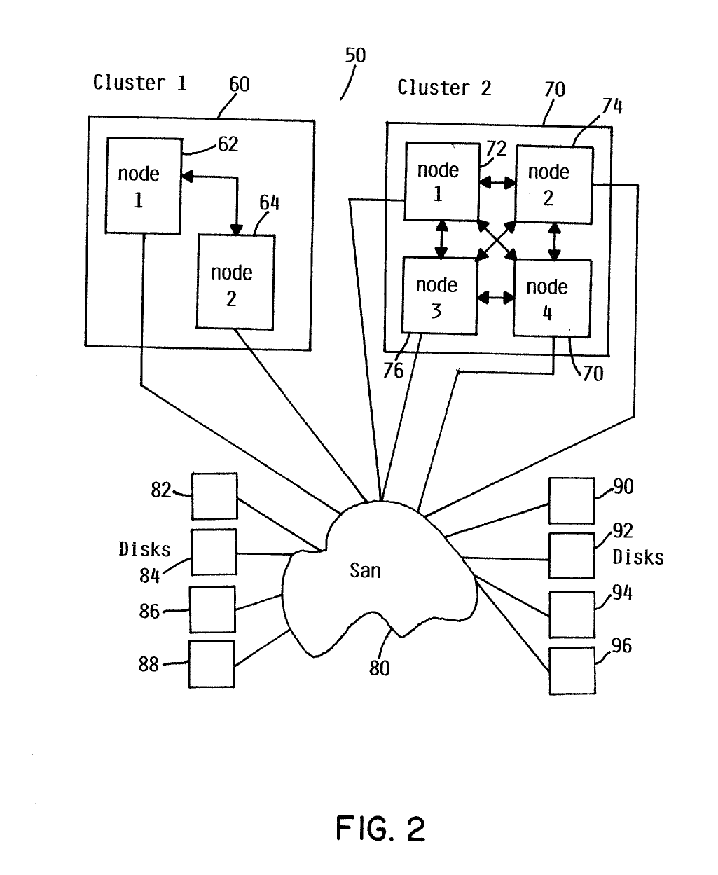

FIG. 2 is a block diagram 50 of a computing environment having two clusters 60 and 70 and a storage area network 80. The first cluster 60 includes two nodes 62 and 64, and the second cluster 70 includes four nodes 72, 74, 76 and 78. Each of the clusters 60 and 70 operates as a single homogeneous cluster environment. However, in the environment shown herein both the nodes 62 and 64 in the first cluster 60 and the nodes 72, 74, 76 and 78 in the second cluster 70 are individually connected to the storage area network 80. In addition, the system includes a plurality of storage media 82-96 which are also in communication with the storage area network 80. The interconnection of each of the nodes in the first cluster 60 and each of the nodes in the second cluster 70 with the storage area network 80, as well as the interconnection of each of the storage media 82-96 with the storage area network, allows each of the nodes in the clusters 60 and 70 to access each of the storage media 82-96 in the computing environment.

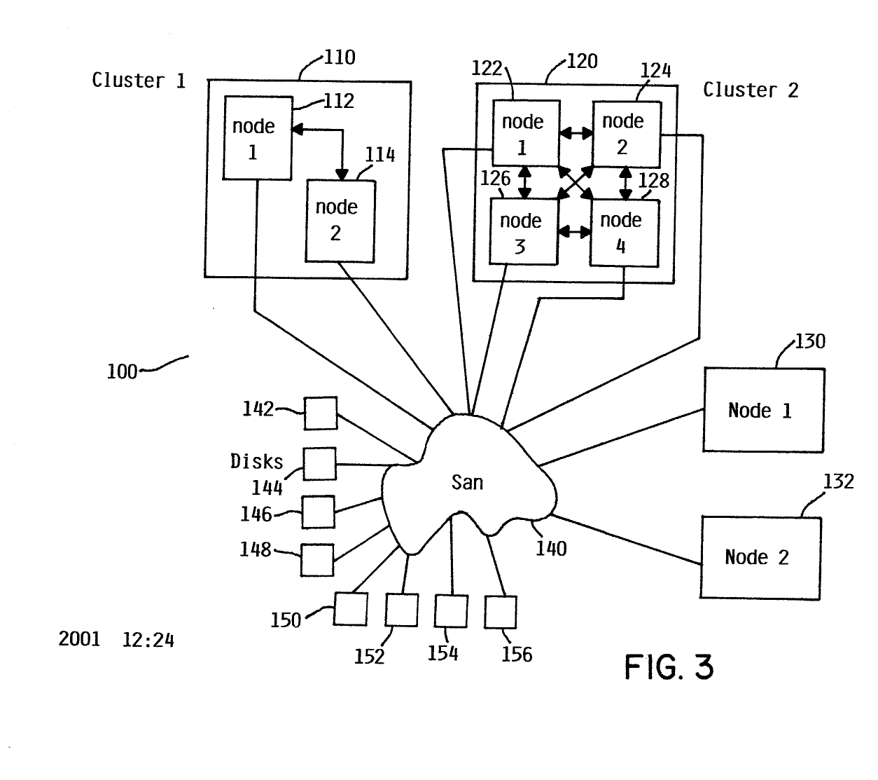

FIG. 3 is a block diagram 100 of a computing environment having two clusters 110 and 120, two independent nodes 130 and 132, and a storage area network 140. The first cluster 110 includes two nodes 112 and 114, and the second cluster includes four nodes 122, 124, 126 and 128. Each of the clusters operates as a single homogeneous cluster environment. In the computing environment shown herein, the nodes in the first cluster 110, the nodes in the second cluster 120, and each of the independent nodes 130 and 132 are individually connected to the storage area network 140. In addition, the environment includes a plurality of storage media 142-156 which are also in communication with the storage area network 140. The interconnection of the nodes in the first cluster 110, the nodes in the second cluster 120, and both of the independent nodes 130 and 132 with the storage area network 140, as well as the interconnection of each of the storage media 142-156 with the storage area network 140, allows each of the nodes in clusters 110 and 120 and independent nodes 130 and 132 to access each of the storage media 142-156 in the computing environment. Accordingly, the interconnection of each independent node and each node within each cluster enables access to the storage media from any of the nodes in the computing environment.

FIGS. 1, 2 and 3 illustrate alternative physical configurations with interconnected nodes and/or clusters that are in communication with a storage area network. The interconnection of the system in each illustrated environment allows each node to access the shared storage media. However, in sharing storage media in each of the illustrated environments it is critical to provide safe access to the storage media. Safe access to the shared storage media ensures coherency of changes to the data stored within the media.

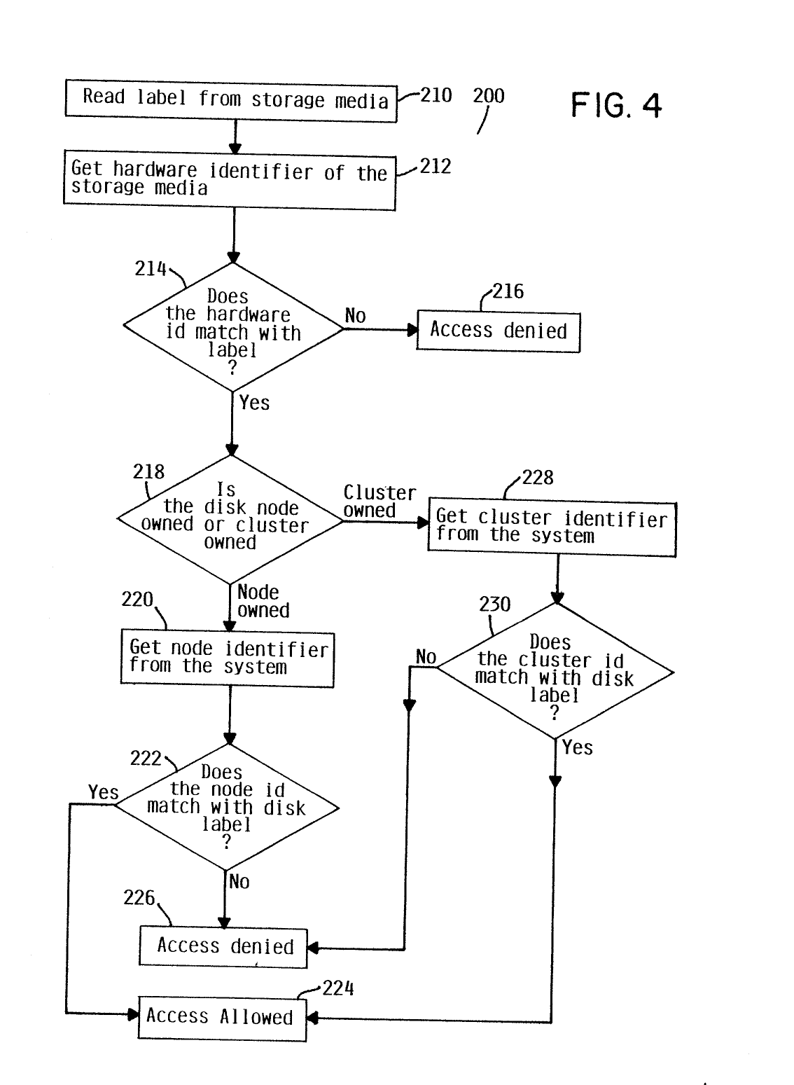

FIG. 4 is a flow chart 200 illustrating the process for a node to safely access shared storage media. Each storage media has a label or other indicia of identification written to associated storage media. The associated storage media includes the storage media itself, flash RAM associated with a SCSI disk, storage in a RAID storage system, or any other storage which is associated with the storage media. Coherency of the label in the media is maintained by atomic read or write operations. The label includes multiple fields, including a hardware identifier field or other hard attribute, a type field, a node identifier field, and a cluster identifier field. The hardware identifier field originates from the manufacturer of the storage media and is typically based upon immutable properties of the media, such as a SCSI vendor and a product number and a serial number. The type field is created by an operator of the storage media at the time of initialization of the media, and indicates if the storage media is node owned or cluster owned. The node identifier field is a string or integer created by the operator at the time of initialization of the media and is generally indicative of the owning node for the media. The cluster identifier field is a string or integer created by the operator at the time of initialization of the media and is generally indicative of the owning cluster for the media. In addition to the four identifying fields disclosed herein, the label may include additional fields for providing enhanced access protection for the storage media. Because the label is determined in part by the hardware identification or other hard attribute, the label is unique for each storage media. The label is used to limit access to the storage media by the nodes and/or nodes in the clusters that have physical access to the media.

As shown in FIG. 4, the first step in determining a node's access rights to a storage media is reading the label from the storage media 210. Thereafter, the accessing node must obtain the hardware identifier from the storage media 212. The accessing node must then compare the hardware identifier of the storage media with the hardware identifier field of the label 214. If the hardware identifier of the storage media and hardware identifier field of the label do not match, then the accessing node is denied access to the storage media 216 because the label has been determined to be invalid. However, if the hardware identifier of the storage media and hardware identifier field of the label do match, then the accessing node must determine if the storage media is node owned or cluster owned 218. Each storage media will either be node-owned or cluster-owned. If the storage media is node-owned, the node identifier for the node is obtained 220. Thereafter, a comparison of the node identifier of the node with the node identifier provided in the label is conducted 222. If the node identifier of the node matches the node identifier provided in the label, then the accessing node is allowed access to the storage media 224, otherwise the accessing node is denied access to the storage media 226. Accordingly, this procedure allows safe access to the storage media only by a node owning the storage media.

As mentioned above, each storage media in the system is either node-owned or cluster-owned, and is identified as such in the label of the storage media. A determination of the form of ownership is conducted at step 218. If the storage media is cluster-owned, the cluster identifier from the node is obtained 228. Thereafter, a comparison of the cluster identifier of the node with the cluster identifier provided in the label is conducted 230. If the cluster identifier of the node matches the cluster identifier provided in the label, then the accessing node in the cluster is allowed access to the storage media 224, otherwise the accessing node in the cluster is denied access to the storage media 226. Accordingly, the procedure for determining access rights of a node in a cluster to a storage media utilizes a label reflecting a unique hardware identifier or other hard attribute to ensure a node in a cluster has proper authorization for safe access to the storage media.

The label utilized in the procedure outline in FIG. 4 has a minimum of four fields. Each of these fields are used for determining a node's access to storage media in a storage area network. However, the label may be formatted to include additional field for additional access rights. For example, the type field may be expanded to include a combination of a cluster identifier and a node identifier. This expanded type field would limit access to the storage media to a specific node in a specific cluster. A fifth field that can be added to the label is a user defined name for the storage media. This field can be used for ease in locating the storage media at the time of booting the system. A sixth field that can be added to the label is an operating system defined name for the storage media. This field can be used to avoid naming conflicts of multiple media in a storage area network in a clustered environment. Finally, the label can be expanded to include an activity counter as a seventh field and an activity interval as an eighth field. The activity counter field and activity interval field can be used together to protect a storage media when an administrator from a node accidentally tries to change the ownership of the storage media which is being accessed by another node. Accordingly, the label may be expanded to include additional fields which would provide enhanced safety features or utility when accessing storage media in a storage area network.

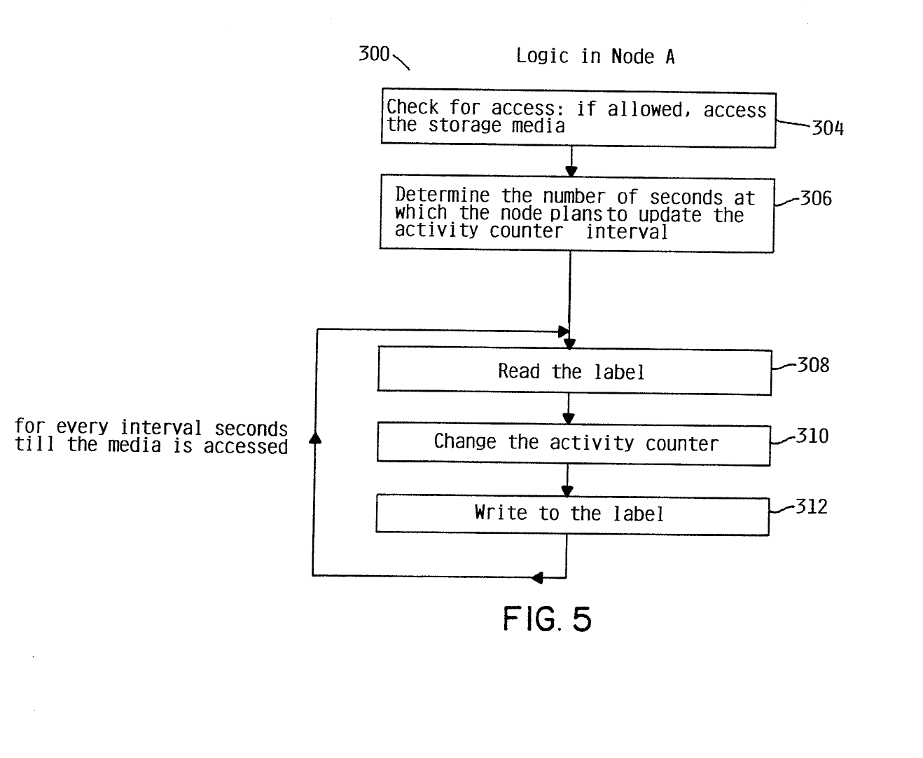

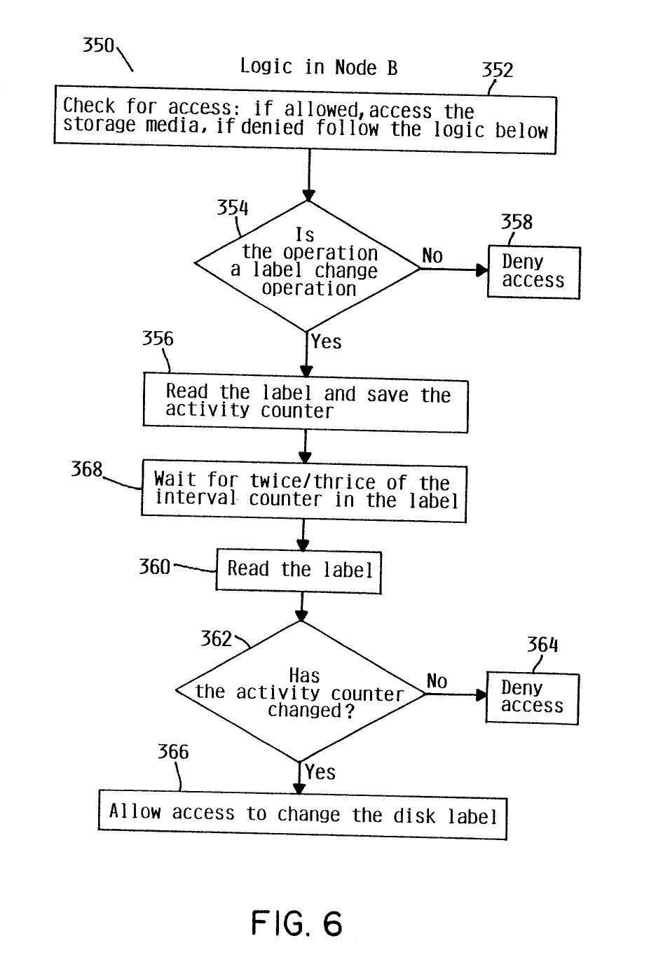

FIGS. 5 and 6 are flow diagrams 300 and 350, respectively, illustrating the details of utilizing the supplementary activity counter field and activity interval field of the label. As explained briefly above, these two fields work in conjunction for preventing a change in storage media ownership when the storage media is in use by another node. Therefore, usage of the activity counter and activity interval fields will be illustrated with reference to two nodes, node₀ and node₁. FIG. 5 illustrates the process for node₀, and FIG. 6 illustrates the process for node₁. As shown in FIG. 5, prior to utilizing either of these supplementary fields, node₀ must first determine access rights to the storage media 304, as illustrated in FIG. 4. Once it has been determined that node₀ has access to the storage media, node₀ must determine the interval at which node₀ plans to update the activity counter 306. Thereafter, node₀ reads the label of the storage media 308. The activity counter is then changed 310, followed by node₀ writing to the label 312 with the new activity counter value and new activity interval value of the storage media. This implementation changes the activity counter for every activity interval as long as nodes is accessing the storage media. Accordingly, the process of changing the activity counter field by nodes accessing the storage media and writing the label to the storage media is indicative of use of the storage media by the owner of the storage media.

FIG. 6 is a flow chart 350 illustrating the process of allowing access to a shared storage media for the purpose of changing the label of the storage media by node₁. As illustrated in FIG. 4, node₁ must determine access rights to the storage media 352 and ownership of the storage media prior to changing the label. If node₁ has access privileges to the storage media, it can change the contents of the label. Otherwise, if it has been determined that node₁ does not have access rights to the storage media, node₁ must determine if the desired operation of node₁ is to change the label of the storage media 354. If node₁ desires to change the label of the storage media, then it proceeds to read the label and save the activity counter field from the label 356, otherwise access to change the label is denied 358. Following step 356, node₁ waits for a period of at least twice the activity interval period in the label 358 plus an amount of time to compensate for discrepancies in time drift of the nodes in the SAN. Thereafter, node₁ reads the label from the storage media 360, and compares the activity counter of the label 362 from step 356 and step 360. If the activity counter has changed from steps 356 to 360, access to the storage media by node₁ to change the label is denied 364. However, if the activity counter from steps 356 to 360 is not changed, then node₁ is allowed access to the storage media to change the label 366. Accordingly, the process outlined in FIG. 6 demonstrates how a node that wants to change the label of a storage media is only allowed to make such a change if the activity counter is static.

### Advantages Over the Prior Art

The preferred embodiment of the invention provides a method for preventing unauthorized nodes and/or clusters from accessing storage media in a storage area network. The method outlined in the preferred embodiment enables the storage area network to be configured with as many storage subsystems as the hardware can support. The use of the hard attribute-based label for enabling safe access to the storage media protects each storage media individually. Each node and/or cluster can have their own set of storage subsystems which are each individually and independently protected under the label and associated access algorithm. In addition, since the information pertaining to storage media ownership is stored in the media itself, the operator can move the media to a different physical location within the computing environment without affecting the ownership of the media. Ownership of the storage media is maintained in the label and is not dependent on the hardware properties of system busses. In addition, the ownership of a storage media can be reassigned to a node or a cluster through software without requiring physical location of the storage media. Finally, the hard attribute—preferably consisting of the hardware identifier combining the vendor number, product number and serial number integer or string—in a field of the label ensures that the label belongs to the storage media. This assists in differentiating the original storage media from a copy of the storage media when the contents of the storage media are copied in totality. Accordingly, the advantages of the use of the label in combination with the access algorithm is the maintenance of the ownership and access privileges to the storage media on the storage media itself and independent of the system in which the storage media is physically connected.

### Alternative Embodiments

It will be appreciated that, although specific embodiments of the invention have been described herein for purposes of illustration, various modifications may be made without departing from the spirit and scope of the invention. In particular, a method for allowing a node and/or cluster to have read and write access to the storage media may be provided. This would require defining additional fields in the label, such as a set of read cluster identifiers and a set of read node identifiers. The method for allowing read and write access to the storage media may be implemented in the procedure for accessing shared storage media outlined in FIG. 4. If at step 226 access to the storage media is denied, the node and/or cluster may review whether the request to access the storage media is only for read access. A positive response to this query would then require a comparison of the node identifier of the node with a list of read node identifiers in the label. If the node identifier is present in the list of read node identifiers, then access to the storage media is allowed. Otherwise, a comparison of the cluster identifier of the cluster with a list of read cluster identifiers in the label is conducted. If the cluster identifier is present in the list of read cluster identifier, then access to the storage media is allowed, otherwise access to the storage media is denied. In addition, the storage media can be divided into partitions, with each partition having its own label. Therefore, each partition in a storage media can be owned by a different node and/or cluster. Finally, another unique identifier can substitute for the hardware identifier as the hard attribute in the label. Accordingly, the scope of protection of this invention is limited only by the following claims and their equivalents.

We claim:

1. A method for safely accessing shared storage media in a computing environment having two or more nodes comprising:
(a) establishing access rights of at least two of said nodes to said storage media, said establishing access rights being responsive at least in part to a hard attribute of associated storage media; and
(b) accessing said storage media by one of said at least two of said nodes in response to said access rights.

2. The method of claim 1, wherein said hard attribute comprises a hardware identifier field, including a vendor, product, and a serial number of said storage media.

3. The method of claim 1, wherein said establishing access rights creates a label including said hard attribute, a type field, and a node identifier field.

4. The method of claim 3, further comprising the step of allowing access of a node to said storage media if said type field indicates said storage media is node-owned and said node identifier matches a node identifier of said node.

5. The method of claim 3, wherein said label further includes:
a cluster identifier field; and
further comprising the step of allowing access of a node in a cluster to said storage media if said type field indicates said storage media is cluster-owned and said cluster identifier matches a cluster identifier of said node.

6. The method of claim 3, wherein said label further includes an activity interval field and an activity counter field for protecting ownership of said storage media.

7. The method of claim 1, wherein the computing environment is a storage area network.

8. A computing environment comprising:
two or more nodes;
shared storage-media;
associated storage media having a hard attribute; and
an access manager for each of at least two of said nodes, said manager being responsive at least in part to said hard attribute.

9. The system of claim 8, wherein said hard attribute comprises a hardware identifier field, including a vendor, a product, and a serial number of said storage media.

10. The system of claim 8, wherein said access manager is responsive at least in part to a label, said label including said hard attribute, a type field, and a node identifier field.

11. The system of claim 10, further comprising a positive access response from said access manager if said type field indicates said media is node-owned and said node identifier field matches a node identifier of said node.

12. The system of claim 10, wherein said label further includes a cluster identifier field; and
further comprising a positive access response from said access manager if said type field indicates said media is cluster-owned and said cluster identifier matches a cluster identifier of said node.

13. The system of claim 10, wherein said label further comprises an activity data field and an activity counter field to protect ownership of said media.

14. An article comprising:
a computer-readable signal-bearing medium;
means in the medium for accessing shared storage media, said storage media having associated storage media having a hard attribute;
means in the medium for establishing access rights of at least two nodes to said storage media at least in part in response to said hard attribute; and
means in the medium for managing an access request to said storage media in response to said access rights.

15. The article of claim 14, wherein the medium is selected from the group consisting of: a recordable data storage medium and a modulated carrier signal.

16. The article of claim 14, wherein said managing means grants a positive access request to a node responsive to confirmation of node ownership of said media.

17. The article of claim 14, wherein said managing means grants a positive access request to a node in a cluster responsive to confirmation of cluster ownership of said media.

18. A method for safely accessing shared storage media in a computing environment having two or more nodes comprising:
(a) writing a label, said label being determined at least in part by a hardware identifier of associated storage media of said storage media, said hardware identifier including a serial number of said storage media;
(b) establishing access rights of a node to said storage media responsive to said label; and
(c) determining a node's responsibility for coordinating access to said storage media responsive to said label.

19. The method of claim 18, further comprising the step of allowing access of a node to said storage media if a type field in said label indicates said storage media is node-owned and a node identifier in said label matches a node identifier of said node.

20. The method of claim 18, further comprising the step of allowing access of a node in a cluster to said media if a type field in said label indicates said storage media is cluster-owned and a cluster identifier in said label matches a cluster identifier of said node.
